(19) United States
(12) Patent Application Publication
(10) Pub. No.: US 2008/0074276 A1
(43) Pub. Date: Mar. 27, 2008

(54) Data Acquisition System

(75) Inventors: Emilio J. Valencia, Merritt Island, FL (US); Priscilla C. Stanley, Titusville, FL (US); Paul J. Mackey, Merritt Island, FL (US)

Correspondence Address: NASA JOHN F. KENNEDY SPACE CENTER, MAIL CODE: CC-A/OFFICE OF CHIEF COUNSEL, ATTN: PATENT COUNSEL, KENNEDY SPACE CENTER, FL, 32899, US

(73) Assignee: USA as Represented by the Administator of the National Aeronautics and Space Ad, Washington, DC (US)

(21) Appl. No.: 11/534,692

(22) Filed: Sep. 25, 2006

(51) Int. Cl. G08B 21/00

(52) U.S. Cl. 340/635; 340/945

(57) ABSTRACT

The Radio Frequency Health Node (RFHN) provides a method for remotely configuring wireless/wired sensors and accessing the sensor data during flight or other remote activity. The RFHN may integrate the sensors into a higher-level data stream by sending the data to a management facility. Access to the sensors can be made available remotely through the management facility allowing operators to send commands to and receive data from the RFHN and the array of wireless/wired sensors.

### ORIGIN OF THE INVENTION

The invention described herein was made by employees of the United States Government and may be manufactured and used by or for the Government of the United States of America for governmental purposes without the payment of any royalties thereon or therefor.

### TECHNICAL FIELD OF THE INVENTION

The present invention relates generally to data acquisition systems and, in particular, to a radio frequency health node wireless sensor data acquisition system.

### BACKGROUND OF THE INVENTION

Electrical systems are critical to the safe operation of aircraft and spacecraft, and wiring is typically used to distribute power and communication signals throughout these systems. NASA's Space Shuttles each currently contain approximately 230 miles of wiring while commercial aircraft, such as the McDonnell Douglas DC-9, may contain approximately 300 miles of wiring.

Electrical wire consists of a conductor that is encased in a protective layer of insulation. Wire is typically routed throughout a craft in a series of bundles with clamps and connectors. Safe routing practices include measures to prevent wires from wear, abrasion, contamination, and contact with other components; to gently bend and turn wires during installation to prevent cracking of the insulation; and to physically separate wires from systems whose signals may interfere with one another.

When the protective layer of insulation on a wire is compromised and the conductor is exposed, the potential exists for a hazardous electrical system malfunction caused by a short circuit or an arc. A short circuit occurs when electricity takes an unintended path. For example, condensation and other conductive materials that are sometimes found on wire bundles can bridge the gap between a wire conductor and adjacent metallic structure. When electrical current follows the unintended path to the metallic structure, a short circuit that could interrupt the function of an electrical system occurs. Short circuits can transfer power to adjacent wires or draw an excessive current from the power source, overheating wires and creating fire hazards. Electrical arcing is a type of short circuit in which high voltage occurs and current crosses a gap, emitting sparks. The sparks include molten material from the wire conductor as it is vaporized by the high energy discharge, producing extremely localized heat. The arcing could ignite flammable products in the area and could potentially initiate an explosion.

Electrical hazards can become even more critical in extreme environments, such as experienced by space vehicles, such as the NASA Orbiter and commercial expendable launch vehicles. Prototype wireless instrumentation systems have been installed in Orbiters as a result to test the feasibility of the systems. The wireless instrumentation system data is made available in two ways: (1) The data can be dumped from the wireless sensors to a laptop computer during post-landing operations, or (2) The data can be accessed by an onboard Payload General Support Computer (PGSC) if the wireless transmitters (i.e. sensors) are in the line of sight of the crew module windows during the mission. Neither of these methods is sufficient to insure that wireless sensor information from all Orbiter locations (crew module, aft, payload bay, wings) can be viewed by the crew or Orbiter systems in real time.

Setting up the pre-launch configuration of the current suite of wireless sensors requires physical access to the Orbiter's aft compartment. For example, an operations engineer carries a laptop computer, with an appropriate wireless receiver attached, into the Orbiter's aft compartment. The operations engineer then uses the laptop software to set up the wireless sensors for flight. This presents several problems. If the Orbiter's aft compartment is closed out for flight the operations engineer must command the wireless sensors by opening the aft vent doors and sliding the wireless antenna into the aft compartment. If the launch is scrubbed the wireless sensors require reprogramming, e.g., with a new data acquisition start times. For typical launch scrub scenarios, the launch pad service platforms are not reinstalled. These service platforms are structures put in place close to the Orbiter that allow operations personnel physical access to different areas of the Orbiter. This means there is no access to the aft vent doors and the sensors cannot be reprogrammed, resulting in the loss of wireless data for that mission.

For the reasons stated above, and for other reasons stated below which will become apparent to those skilled in the art upon reading and understanding the present specification, there is a need in the art for alternative approaches for data acquisition in avionic systems.

### SUMMARY OF THE INVENTION

The various embodiments provide wireless/wired data acquisition systems for the gathering and processing of data from wireless/wired sensors. The various embodiments will be described in relation to use in a NASA Orbiter, but it will be apparent that the systems are useable in a variety of avionic as well as stationary environments. The data acquisition systems center around a radio frequency health node or RFHN. The RFHN provides an RF interface between a set of wireless sensors and a higher-level system, such as the Orbiter Vehicle Health Management System (VHMS). The RFHN also provides the capability to add new sensor types as the need arises. Data that are received from sensors are time stamped by utilizing a timing signal received from VHMS. The time correlated data is sent to VHMS which then integrates it into the vehicle data stream. VHMS will make this data available during flight through the VHMS downlink. The RFHN can be commanded to perform predefined data analysis and provide concise data reporting or to download data up to the RF bandwidth limits. The RFHN provides the capability to reconfigure sensors as required for mission changes (launch scrub, extended mission, or additional data requests), provide simple, remote (firing room) interface for non-intrusive configuration of sensors, and access to sensor data.

For one embodiment, the invention provides a data acquisition system. The data acquisition system includes one or more wireless sensors and a control unit for managing the one or more wireless sensors. The control unit includes at least one transceiver for configuring and receiving data from the one or more wireless sensors, a sequencer to provide autonomous collection of data from the one or more wireless sensors in response to one or more predetermined trigger events, and a sensor data distributor to control a destination of the collected data.

For another embodiment, the invention provides a method of collecting data. The method includes collecting first data from one or more wireless/wired sensors in response to one or more trigger events, converting the first data in response to a configuration file to generate second data, storing the second data, selecting a first format for output data, and encoding the second data for output in response to the selected first format.

The invention further includes methods and apparatus of varying scope.

### BRIEF DESCRIPTION OF THE DRAWINGS

FIG. 1 is a functional block diagram of a data acquisition system of the prior art.

FIG. 2 is a functional block diagram of a data acquisition system in accordance with an embodiment of the invention.

FIG. 3 is a block diagram of the logical interfaces to an RFHN in accordance with an embodiment of the invention.

FIG. 4A is a functional block diagram of the software architecture for an RFHN in accordance with an embodiment of the invention.

FIG. 4B is a functional block diagram of the software architecture for a sequencer in accordance with an embodiment of the invention.

FIG. 5 is a depiction of an example placement of multiple RFHNs within a typical installation in accordance with an embodiment of the invention.

FIG. 6 is a diagram of an RFHN functional architecture in accordance with an embodiment of the invention.

FIG. 7 is the data processing flow diagram of RFHN software in accordance with an embodiment of the invention.

### DETAILED DESCRIPTION OF THE INVENTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical, or mechanical changes may be made without departing from the scope of the claimed subject matter. The following detailed description is, therefore, not to be taken in a limiting sense, and the scope of the claimed subject matter is defined only by the appended claims and equivalents thereof.

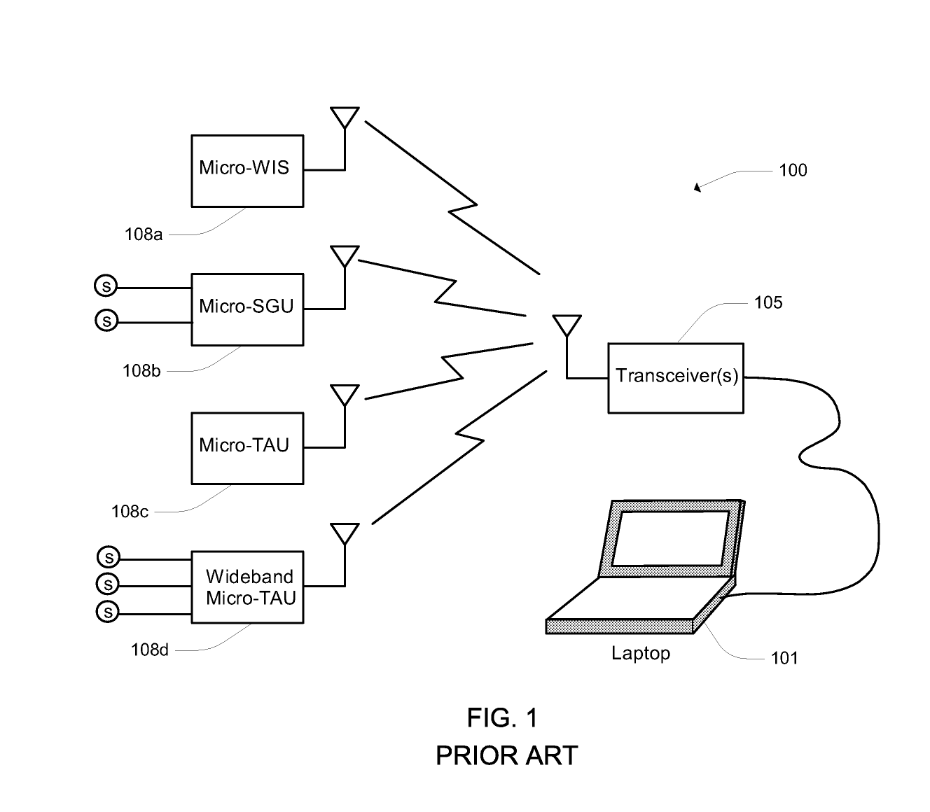

FIG. 1 is a functional block diagram of a data acquisition system 100 of the prior art. Data acquisition system 100 is exemplary of systems as used in NASA Orbiters. The system 100 includes a laptop or other portable programming interface 101 and one or more transceivers 105 for communication with a variety of sensing units 108. Example sensing units 108 include one or more Micro-Wireless Instrumentation System (Micro-WIS) units 108a. Micro-WIS units 108a refer to the suite of wireless resistive sensors, such as strain gauges, resistive thermal devices (RTDs), pressure sensors, humidity sensors, accelerometers, etc., that are battery operated and communicate via RF. Example sensing units 108 may further include one or more Micro-Strain Gage Units (Micro-SGU) 108b. A Micro-SGU 108b measures strain gage measurements from two external sensors. Example sensing units 108 may further include one or more Micro-Tri Axial Units (Micro-TAU) 108c. A Micro-TAU 108c measures data from three external accelerometers. Example sensing units 108 may further include one or more Wideband Micro-Tri Axial Units (Wideband Micro-TAU) 108d. A Wideband Micro-TAU 108d is a high data rate version of the accelerometer sensing unit 108c. It measures data from three external accelerometers up to 10,000 samples/sec and stores it internally. Due to the large amount of data stored internally, the Wideband Micro-TAU may be provided with a USB connection to reduce the download time. Such sensors 108 are commercially available, such as the micro-wireless sensors designed and developed by Invocon, Inc., Conroe, Tex., USA.

Such prior art data acquisition systems for NASA Orbiter operations are configured via RF shortly before a launch. If a launch is delayed or scrubbed, re-programming of the sensors 108 requires line-of-sight access to the units from the laptop 101. Using the laptop 101 to re-program the sensors 108 is a time-consuming manual task that competes with other Orbiter turnaround operations. Additionally, the different sensor types often require different transceivers 105 to communicate with the laptop 101 for configuration and data download.

A wireless instrumentation system in accordance with an embodiment of the invention provides a method to mitigate safety concerns due to aging of wires, provide rapid response to vehicle instrumentation needs, provide a low cost solution for after market instrumentation, reduce the amount of vehicle wiring, and provide building blocks for use in Integrated Systems Health Management (ISHM) technologies.

Data acquisition systems in accordance with embodiments of the invention are used to acquire instrumentation data and include two primary types of components. The first component is the receiving unit called the RFHN (Radio Frequency Health Node) used to manage the sensors and to receive data via a wireless communication link, store, process (if applicable), and forward the sensor data. The second component is the transmitter or wireless sensor used to acquire, process (if applicable), store, and wirelessly transmit the sensor data. The system has the flexibility to be configured as required for each application with different numbers and types of sensors.

The RFHN facilitates a real-time wireless command and data interface to the commercially available wireless sensors and serves as the single point to interface with multiple sensors of multiple types. The RFHN sends commands to the wireless sensors and receives the instrumentation data from the sensors using the wireless link. With an on-board processor, the RFHN has the capability to perform data preprocessing, data fusion, trending, etc.

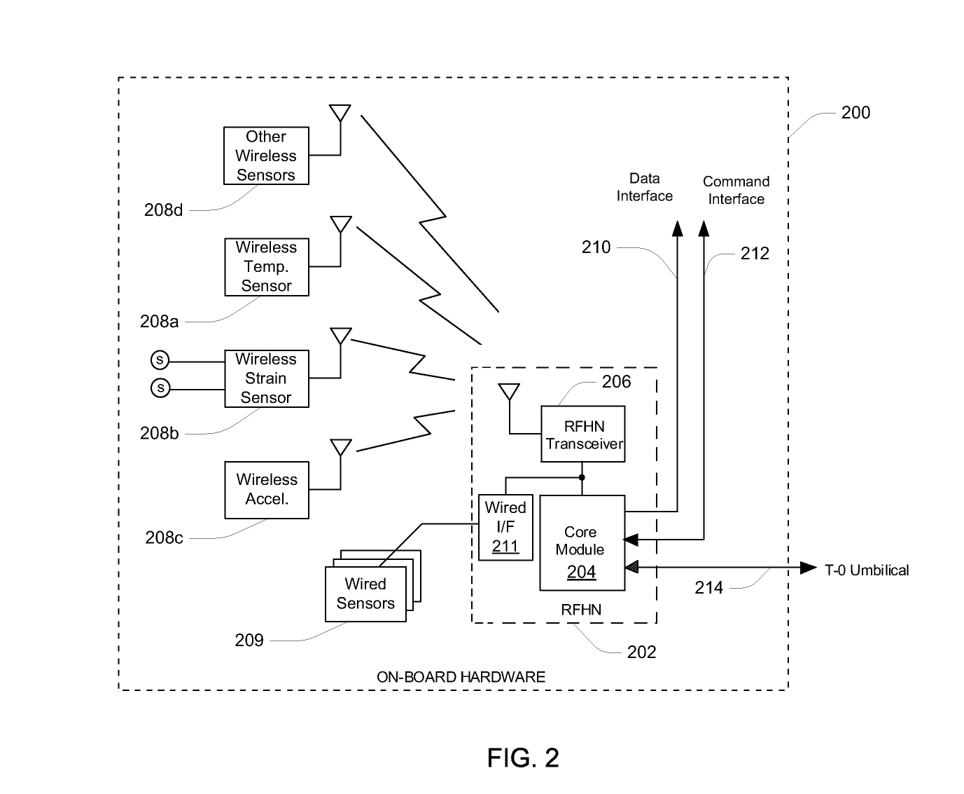

FIG. 2 is a functional block diagram of a data acquisition system 200 in accordance with an embodiment of the invention. For one embodiment, the RFHN hardware is based on the PC 104+ specifications and uses the VxWorks Real-time Operating System (ROS). The RFHN 202 includes a core module 204 and a transceiver module 206 as shown in FIG. 2. The core module 204 provides the generic functions and the transceiver module 206 provides the interface to one or more wireless sensing units 208 while the wired interface 211 provides the interface to one or more wired sensing units 209. The core module 204 can provide such functionality as CPU processing, data storage, power, data output, etc. The core module 204 may include flash or other non-volatile memory for storage of data files.

The transceiver module 206 provides the wireless link and protocol required to communicate with the wireless sensing units 208. The wired interface 211 provides the protocol required to communicate with the wired sensing units 209. For the embodiment shown in FIG. 2, the wireless sensing units 208 can provide sensing of a variety of physical phenomena as described generally with reference to the sensors 108 of FIG. 1. Example sensing units 208 include one or more wireless temperature sensor units 208a, one or more wireless strain sensors 208b, one or more wireless accelerometers 208c, and/or one or more other sensing units 208d for sensing other physical phenomena of interest. Wired sensing units 209 may also be used to sense a variety of physical phenomena discussed with reference to the wireless sensing units 208. The modular design approach of the RFHN allows other transceiver modules to be integrated into the RFHN with minimal impact to accommodate future wireless sensing units.

The RFHN 202 may be controlled and configured prior to launch via the T-0 umbilical 214, e.g., using a serial or Ethernet interface. For one embodiment, the RFHN 202 is adapted to provide autonomous collection of data from the wireless sensing units 208 and wired sensing units 209 in response to one or more predetermined trigger events, e.g., a designated time interval, launch, reentry, landing, alarm indication, etc.

Commercially available wireless sensors units are currently installed in NASA Orbiters and have flown on many flights since 1998. However, the sensor units have predominately been used in a stand-alone configuration and have not wirelessly communicated with other systems during a mission.

The wireless communication within the RFHN 202 and the wireless sensing units 208 is, for one embodiment, based on the 916.5 MHz transceiver chip built by RF Monolithics, Inc. This frequency is located within the ISM frequency allocation of the UHF spectrum. The bandwidth is 50 KHz and the output power is set to one milliwatt. The modulation is set to Amplitude Shift Keying (ASK).

The RFHN 202 as shown in FIG. 2 includes, for one embodiment, on-board flight hardware that communicates with all the installed wireless sensors 208 and wired sensors 209 for configuration and data download. Data gathered during flight is formatted into a PCM stream and may be sent via a data interface 210 to a higher-level system, such as a Vehicle Health Management System (VHMS) or general purpose computer, where it may be recorded and potentially downlinked to an external system. Configuration information and other commands may be passed from the management facility to the RFHN 202 using a command interface 212. The RFHN 202 may further include a T-0 umbilical or other secondary interface 214 to configure the sensors, for example, during pre-launch and launch-scrub activities, to download data during post-landing operations, and to aid in Orbiter processing and testing activities on the ground. The command interface 212 includes a serial command path for control, configuration, and time code. The data interface 210 includes a PCM data path for sensor data that is to be stored on the VHMS or other higher-level system. The secondary interface 214 provides the functionality of the data interface 210 and the command interface 212 while providing the ability to bypass the higher-level system, such as the VHMS. The RFHN 202 does not need to be co-located with the wireless sensors 208 for RF communication since the sensors have a relay function that is used to pass data from one sensor to another.

The following provides an overview of the concept of operations for an exemplary RFHN 202 in a typical installation within a NASA Orbiter, both during flight operations and ground processing. It will be understood that data acquisition systems in accordance with embodiments of the invention are suited for applications and environments other than NASA Orbiters. For example, such data acquisition systems could be utilized in a variety of vehicles for air, sea or land as well as in stationary environments such as within factories.

The RFHN 202 is powered on during the pre-launch countdown. Data is routed to the Launch Control Center (LCC) via the T-0 umbilical 214 as required. Commands may be issued to the RFHN through VHMS using the command interface 212 or the T-0 umbilical 214 for the purpose of configuring the wireless sensors 208 or wired sensors 209.

The RFHN 202 is capable of operating during ascent and may pass data to VHMS for recording. For certain embodiments, only a subset of the wireless sensors 208 and/or wired sensors 209 may transmit data to the RFHN 202 during ascent, such as a temperature sensor 208a. The other sensors 208/209 may store ascent data internally and may pass that data to the RFHN 202 while in-orbit or during post-landing operations.

In-orbit data dumps of wireless sensor 208 and wired sensor 209 data may be scheduled and controlled by ground personnel. The RFHN 202 may be commanded to retrieve data from the wireless sensors 208 and wired sensors 209, and transmit the data to the VHMS through the data interface 210.

The RFHN 202 can be operated in-orbit to configure and collect data from wireless sensors 208 and wired sensors 209. Some sensors 208/209, such as a wireless accelerometer 208c may not be able to download its raw data within a reasonable time frame due to the large quantities of data and limited sensor RF bandwidth. However, the wireless sensor 208c may be programmed to pre-process the raw data and download the processed set of data to the RFHN 202.

The RFHN 202 can further be used to configure the wireless sensors 208 or wired sensors 209 for data collection during reentry and landing. Real-time sensor data is sent to the VHMS for recording via the data interface 210.

If there is an abort, the RFHN 202 may record data (as needed) in a nominal ascent and entry. Commands to modify data collection can be issued through the VHMS using command interface 212 to compensate for the changes in mission time-line.

For one embodiment, the RFHN 202 provides a correlation between an input time source and wireless sensor data. A system time may be provided to the RFHN 202 through the command interface 212, allowing the RFHN 202 to be able to time tag real-time data and pass time on to wireless sensors. This results in wireless sensor data having a time correlation to other Orbiter instrumentation data.

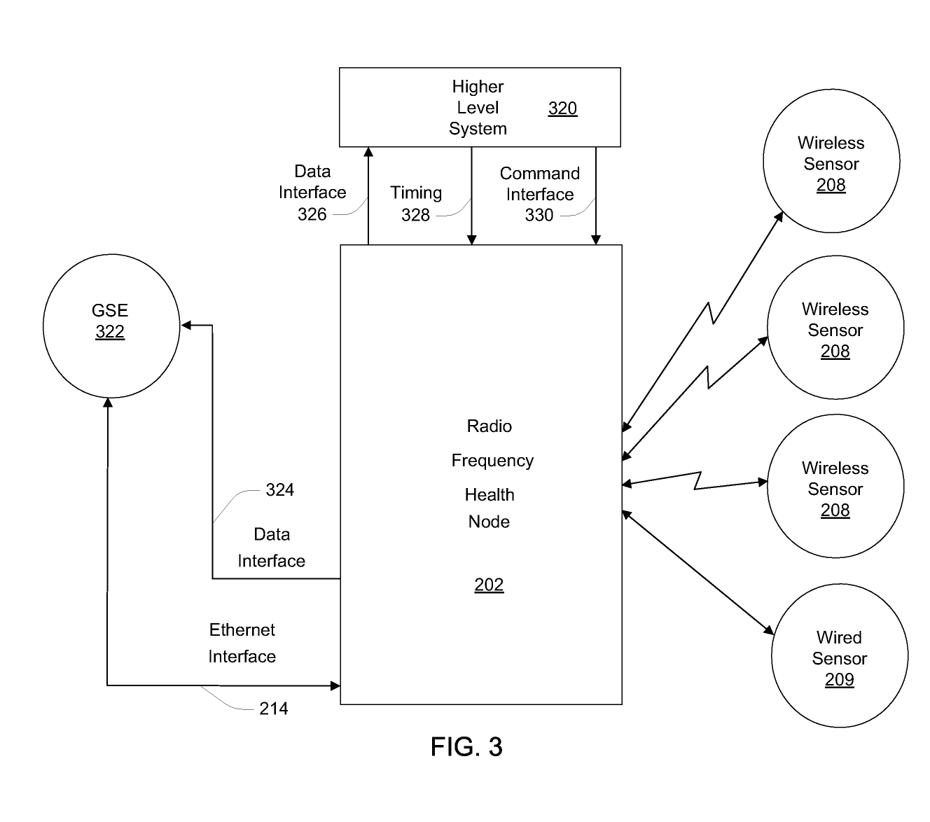

FIG. 3 is a block diagram of the logical interfaces between the RFHN 202, wireless sensors 208, wired sensors 209, a higher-level system 320 and Ground Support Equipment (GSE) 322. The higher-level system 320 provides for configuration and control of the RFHN 202, such as through the wired command interface 330 and may provide time to the RFHN 202, such as through the wired timing interface 328, and may receive data from the RFHN 202 through a wired data interface 326. The RFHN 202 may receive control information from the GSE 322 through Ethernet interface 214 and exchange data via interface 324.

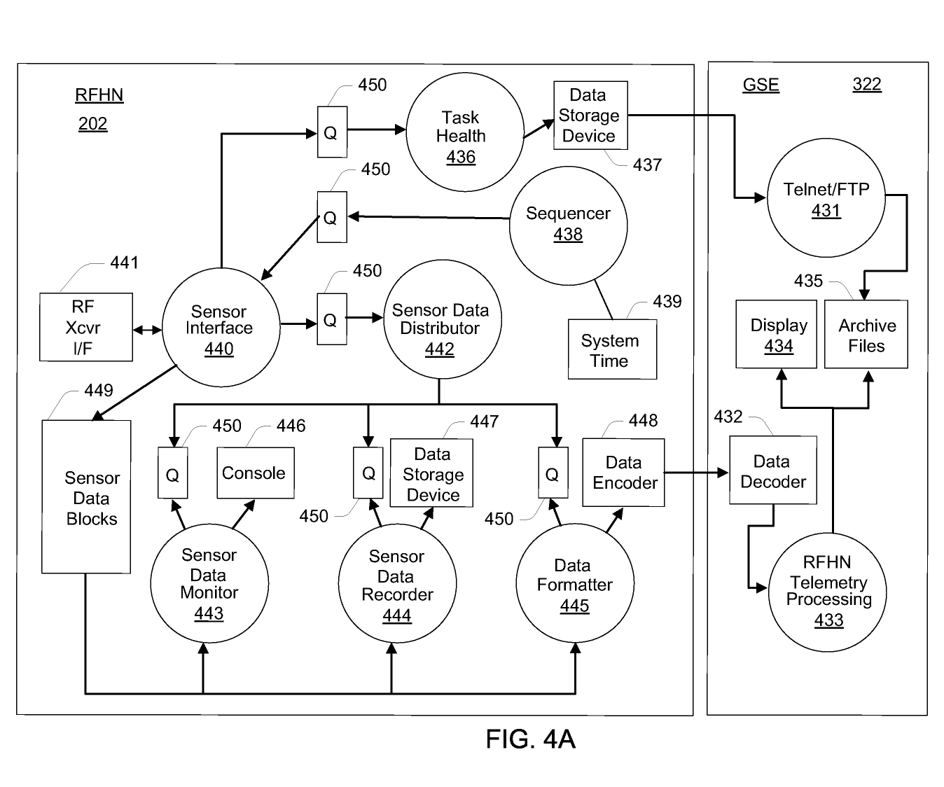

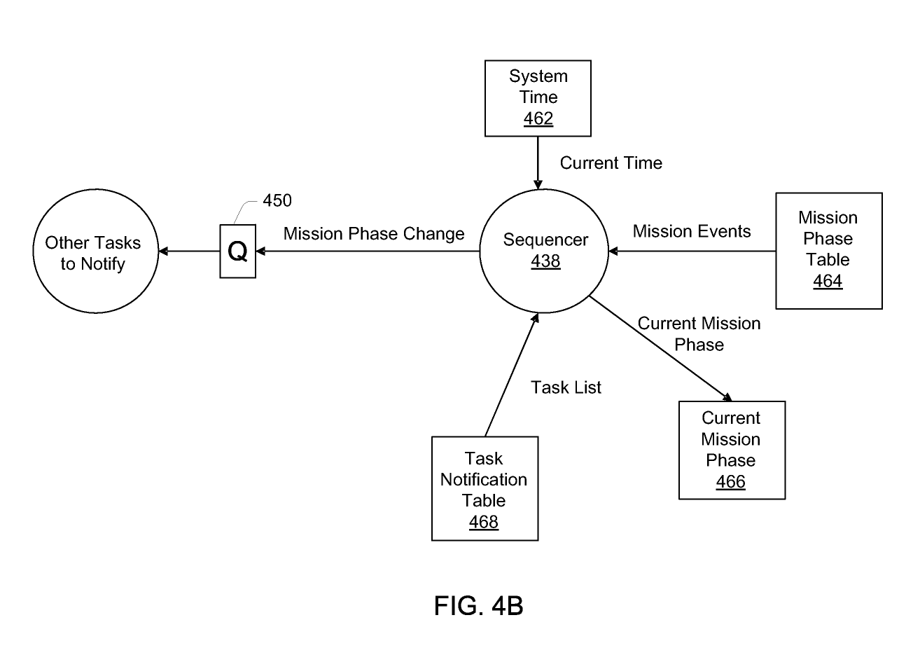

FIG. 4A is a functional block diagram of the software architecture between the RFHN 202 and the GSE 322 in accordance with an embodiment of the invention. The GSE 322 includes a Telnet service and FTP server 431. This provides the capability to telnet to the RFHN 202 and gain access to the console port over one or more command interfaces, and to transfer files from the RFHN 202 for storage in archive files 435.

The GSE 322 further includes a Data Decoder 432 and RFHN Telemetry Processing 433 to handle the de-commutation of the data stream. This data may be used for displays 434 and recorded in archive files 435.

A Task Health service 436 may provide the capability to verify that all required tasks are running. If the Task Health service 436 determines that any required task is not running, it attempts to re-spawn the task. The Task Health service 436 records system error messages and significant system status changes on data storage device 437. This health information may be used to determine the cause of a failure if an error in the data or loss of data occurs during operation.

A Sequencer service 438 may be provided to facilitate notifying tasks when pre-determined mission events occur. The Sequencer service 438 may be provided with a system time 439 for handling time-based events.

The Sensor Interface service 440 provides the capability to transmit commands to the RF Transceiver interface 441 and receive sensor status and data in response. The Sensor Interface service 440 monitors the operation of the transceiver and sensors. The Sensor Interface service 440 defines sensor data blocks 449. The interface requirements will be determined by the sensors chosen for the data acquisition system.

The Sensor Data Distributor service 442 provides the capability to control the destination of the sensor data. The destination may be determined from a routing table indexed by mission phase. The data may be routed to the Sensor Data Monitor 443, the Sensor Data Recorder 444 or the Data Formatter 445.

The Sensor Data Monitor service 443 provides the capability to display sensor data as received to the console port 446. The Sensor Data Recorder 444 provides the capability to record the sensor data on the Data Storage Device 447.

The Data Formatter 445 provides the capability to assemble data frames and transmit them via the Data Encoder 448. The Data Formatter 445 retrieves sensor data from Sensor Data Blocks 449 and assembles the data into frames. The data frames are then transmitted via the Data Encoder 448 to the GSE 322. The data acquisition system may include one or more data queues 450 for management of efficient data flow between the various services.

FIG. 4B is a functional block diagram of the software architecture for a sequencer in accordance with an embodiment of the invention. The Sequencer 438 determines current Mission Phase based on System Time 462 and a Mission Phase Table 464. Mission Phase identifies a particular timeframe during the mission and may be used to change the behavior of other tasks. Some examples of Mission Phases are T−3 minutes to T0 and T0 to T+5 minutes. The Mission Phase Table 464 is built pre-launch and uploaded to the RFHN. The Sequencer 438 monitors System Time 462 and immediately notifies interested tasks, as identified in the Task Notification Table 468, of the mission phase change. Each task is responsible for determining how the behavior should be modified based on this information. For example, a task collecting sensor data may change a sensor's configuration or which sensor's data is being collected and reported. The Current Mission Phase 466 is also stored in a global variable that is available to all tasks and required in case of system restart. In addition, the Sequencer 438 allows the user to override automatic phase detection and force the system to a particular mission phase. This can be used during ground test operations to force the system to operate in a particular mode while test data is collected.

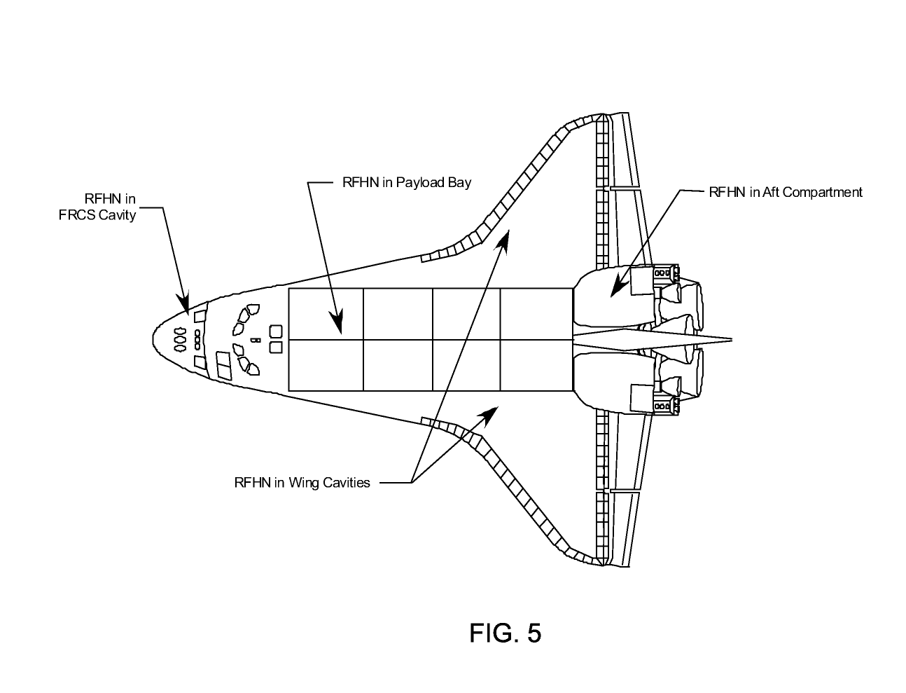

FIG. 5 is a depiction of an example placement of multiple RFHNs within a typical installation, e.g., within a NASA Orbiter, in accordance with an embodiment of the invention. Because the wireless sensors generally need line of sight access to communicate effectively with the RFHN, multiple placements may be required. Note that line of sight need not be a direct visual path between the component, but merely sufficiently free of obstructions or shielding that might interfere with low-power RF communications. Furthermore, wireless sensors can provide a relay function to pass data from one sensor to another such that an individual sensor need not have direct communication with the RFHN. The RFHN may physically mount to locations in the Orbiter where access to wireless sensors is required. Initially, this is expected to include the aft compartment, but could expand to include the right and left wing, payload bay, and Forward Reaction Control System (FRCS) cavity.

The RFHN includes an integral power supply converter that obtains power from an external host device, e.g., the Orbiter power bus and converts the power to the voltages that the RFHN needs. The powered state of the RFHN (active/standby) can be controlled by commands from VHMS or other higher-level system. This power interface would be routed to any of the proposed physical locations of the RFHN as depicted, as one example, in FIG. 5.

The RFHN may interface to VHMS or other higher-level system for command, data, timing, and data downlink and storage. The control and data interface would be routed to any of the proposed physical locations of the RFHN as depicted, as one example, in FIG. 5.

In an Automatic Data Collection state, the RFHN may perform data collection based on predetermined events, such as mission time and mission profile. This data collection information may include data collection start/stop times, data collection rates, and configuration parameters for each sensor.

In a Manual Data Collection state, the RFHN performs data collection based on user commands. The user must supply data collection start/stop and configuration parameters for each sensor by issuing commands in local control state. The data collection operation specified is performed. Once completed, no data collection or recording takes place until another command is issued.

For both Auto and Manual Data Collection states, the user may enable or disable data recording. Enabling data recording causes all data collected to be recorded to non-volatile storage on the RFHN. While data may be sent to a higher-level system, a diagnostic port may additionally or alternatively be used to retrieve the recorded data from the RFHN.

The RFHN is proposed as a modular, processor based design that is both physically and electrically expandable. The standard board interface and stacking frame of the PC/104+ standard allow the module to expand as necessary. This provides for individually removable modules such as the power supply, processor, memory, command interface, data interface, and wireless transceiver interface. The software is also modular in design and based on a real-time operating system which provides a stable, deterministic response.

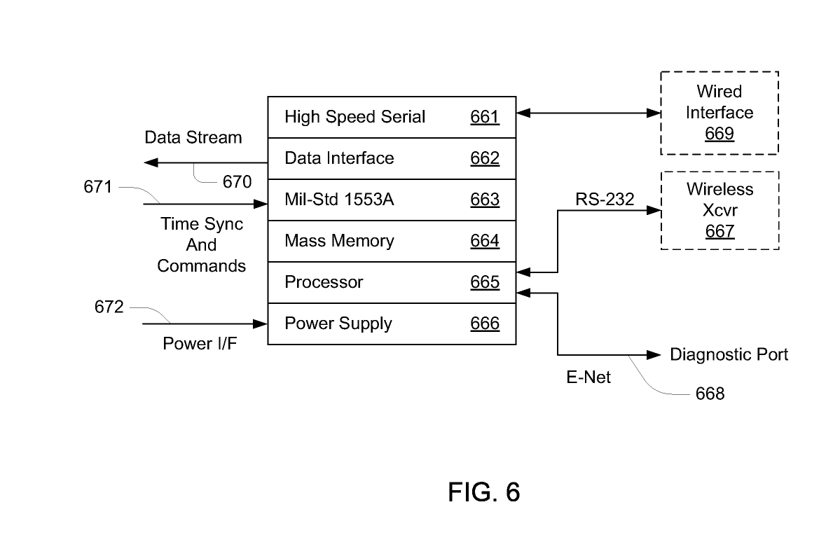

FIG. 6 is a diagram of the RFHN functional architecture in accordance with an embodiment of the invention. The RFHN 200 includes a high speed serial interface 661, a data interface 662, a Mil-Std 1553A or other bus interface 663, a mass memory 664 for non-volatile data storage, a processor 665 and a power supply 666. The processor 665 may be coupled to a wireless transceiver 667 for communication with the wireless sensors of the type described herein or may be coupled with a wired interface 669 for communication with wired sensors. The processor 665 may also be coupled to a diagnostic port 668, such as a T-0 interface, for loading software or commands for testing. One or more additional transceivers may be coupled to the high speed serial interface 661 to allow the RFHN to interface to future wireless sensors without physically modifying the core module. The data interface 662 provides the encoded data stream 670. Timing synchronization and commands 671 are provided through the bus interface 663. As noted previously, the power supply 666 may optionally be coupled to a power interface 672 to receive power from an external host.

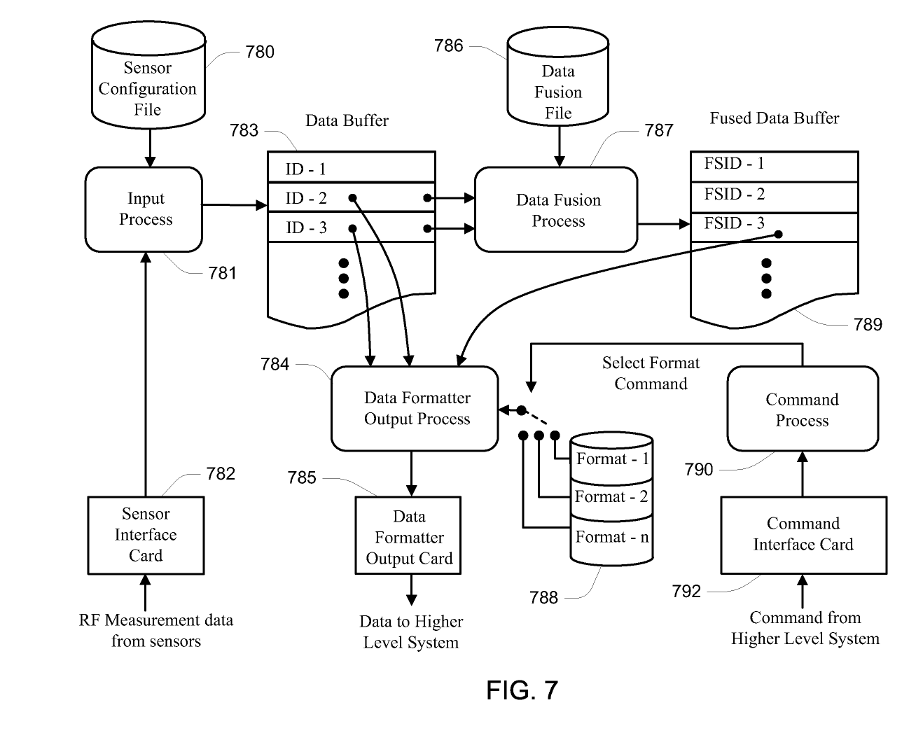

FIG. 7 is the data processing flow of the RFHN software architecture in accordance with an embodiment of the invention. The modular design allows sensors to be configured by downloading a file during mission configuration and does not require a new software load. Similarly, predefined computations on collected data, known as “data fusion,” can also be controlled by file downloads.

In FIG. 7, raw sensor data is received at sensor interface card 782. The input process module 781 receives sensor configuration information from sensor configuration file 780 to convert raw sensor data into a representation of a physical phenomena. For example, where a sensor is a thermal resistive sensor, raw information may be a value in ohms, and the sensor configuration file 780 provides information for the input process module 781 to convert that to a temperature reading. The processed data from input process module 781 is then stored in a data buffer 783 in individual master data files associated with each sensor ID, e.g., ID-1, ID-2, ID-3, etc.

The data in data buffer 783 may further be processed to increase the information value of the output data by converting the collected data to higher-level information. For example, a master data file may contain pressure readings of a helium tank. This data may be converted into a leakage rate on the tank through a data fusion process module 787. The data fusion file 786 is a configuration file that would provide the necessary calculations or other manipulations of data contained in the data buffer 783 to generate this fused data. The fused data would then be stored in a fused data buffer 789 as fused files associated with a sensor ID or other identifier. Note that fused data may involve calculations based on more than one sensor. To take the example of a helium tank leakage rate one step further, a temperature sensor may measure a temperature of the helium tank. It would thus be prudent to account for changes in both pressure and temperature of the tank in order to accurately determine a leakage rate.

Data may be output from either the data buffer 783 or the fused data buffer 789 using the data formatter output process module 784 through the data formatter output card 785. The data formatter output process module 784 encodes the data string according to one or more format files 788. The format files 788 define one or more of a size, data rate, Major Frame, and Minor Frame data for particular data output formats. A variety of data formats may be utilized, e.g., standardized data formats such as PCM (Pulse Code Modulation) or IRIG (Inter-Range Instrumentation Group) formats, or non-standard or user customized formats. Commands received at the MIL-STD-1553 or other command interface card 792 are processed by command process module 790 to select a format from the format files 788.

### CONCLUSION

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

We claim:

1. A data acquisition system, comprising:
one or more wireless sensors; and
a receiving unit for managing the one or more wireless sensors, wherein the receiving unit comprises:
at least one transceiver for configuring and receiving data from the one or more wireless sensors;
a sequencer to provide autonomous collection of data from the one or more wireless sensors in response to one or more predetermined trigger events; and
a sensor data distributor to control a destination of the collected data.

2. The data acquisition system of claim 1, further comprising:
one or more wired sensors;
wherein the receiving unit further comprises at least one wired interface for configuring and receiving data from the one or more wired sensors; and
wherein the sequencer is configured to further provide autonomous collection of data from the one or more wired sensors in response to one or more predetermined trigger events.

3. The data acquisition system of claim 1, wherein the system is further adapted to accept a system time from an external host, to time tag at least a portion of the received data with the system time, and to pass the system time to one or more of the wireless sensors.

4. The data acquisition system of claim 1, wherein at least one transceiver is based on a selected frequency, bandwidth, and output power.

5. The data acquisition system of claim 1, wherein the trigger events include at least one trigger event selected from the group consisting of a designated time interval, a mission stage, and an alarm indication.

6. The data acquisition system of claim 1, wherein the sensor data distributor is adapted to control a destination of the collected data selected from the group consisting of a display, a data storage device, and a data formatter.

7. The data acquisition system of claim 6, wherein the data acquisition system is coupled to a higher-level system for receipt of commands selecting a desired format for data sent to the data formatter.

8. The data acquisition system of claim 7, wherein the format defines at least one of a size, data rate, Major Frame, and Minor Frame data for a particular PCM output format.

9. The data acquisition system of claim 1, wherein the sequencer is coupled to receive a system time for time-stamping the collected data.

10. The data acquisition system of claim 9, wherein the data acquisition system is coupled to a higher-level system for receipt of the system time.

11. The data acquisition system of claim 1, further comprising:
a data fusion process module for manipulating collected data into a higher-level form of information.

12. The data acquisition system of claim 11, wherein the data fusion process module is adapted to process first data collected from one or more of the wireless sensors to generate second data representing a different phenomena than the first data.

13. A method of collecting data, comprising:
collecting first data from one or more wireless/wired sensors in response to one or more trigger events;
converting the first data in response to a configuration file to generate second data;
selecting a first format for output of the second data; and
encoding the second data for output in response to the selected first format.

14. The method of claim 13, further comprising:
storing the second data prior to encoding the second data for output.

15. The method of claim 13, wherein the trigger events include at least one trigger event selected from the group consisting of a designated time interval, a mission stage, and an alarm indication.

16. The method of claim 13, wherein selecting a first format further comprises selecting an output format selected from the group consisting of standardized data formats and user customized data formats.

17. The method of claim 16, wherein the output format defines at least one of a size, data rate, Major Frame, and Minor Frame data.

18. The method of claim 13, further comprising:
manipulating the second data to generate third data representing a different phenomena than a phenomena represented by the second data.

19. The method of claim 18, wherein manipulating the second data further comprises manipulating second data associated with more than one of the wireless/wired sensors to generate the third data.

20. The method of claim 18, further comprising:
selecting a second format for output of the third data; and encoding the third data for output in response to the selected second format.

21. The method of claim 20, further comprising:
storing the third data prior to encoding the third data for output.

22. The method of claim 13, wherein the one or more wireless/wired sensors are located in a host device and one or more of the trigger events are relative to a status of the host device.

23. The method of claim 13, wherein the one or more wireless/wired sensors are located in a host device and selecting a first format is in response to commands received from a process of the host device.
